(19) United States
(12) Patent Application Publication
(10) Pub. No.: US 2020/0286152 A1
(43) Pub. Date: Sep. 10, 2020

(54) METHOD FOR COMPUTER-ASSISTED DETERMINATION OF A COSMETIC PRODUCT

(71) Applicant: Henkel AG & Co. KGaA, Duesseldorf (DE)

(72) Inventors: TILAK THIAGARAJAN, Duesseldorf (DE); MAX KEIL, Duesseldorf (DE); HANS GEORG KNUEBEL, Duesseldorf (DE)

(73) Assignee: Henkel AG & Co. KGaA, Duesseldorf (DE)

(21) Appl. No.: 16/648,215

(22) PCT Filed: Oct. 1, 2018
(86) PCT No.: PCT/EP2018/076636

§ 371 Date: Mar. 17, 2020

(30) Foreign Application Priority Data
Oct. 5, 2017 (DE) 10 2017 217 727.6

(51) Int. Cl. G06Q 30/06; G06K 7/14

(52) U.S. Cl. CPC G06Q 30/0631; G06K 7/1417; G06Q 30/0639; G06Q 30/0623

(57) ABSTRACT

A method for computer-assisted determination of a cosmetic product is provided. The method includes providing an activation signal to a portable data-processing device, the activation signal being configured to activate software in the portable data-processing device, providing product category information and user location information to the portable data-processing device, providing a plurality of possible target states in the portable data-processing device, taking into account the product category information, selecting a desired target state from the plurality of possible target states by the user, determining at least one cosmetic product which is suitable for bringing about the desired target state from a manufacturer-independent plurality of cosmetic products for which data on achievable states is stored in an external database, determining an availability of the at least one cosmetic product at the user location and presenting the at least one cosmetic product taking into account the availability at the user location.

### CROSS-REFERENCE TO RELATED APPLICATION

This application is a U.S. National-Stage entry under 35 U.S.C. § 371 based on International Application No. PCT/EP2018/076636, filed Oct. 1, 2018, which was published under PCT Article 21(2) and which claims priority to German Application No. 10 2017 217 727.6, filed Oct. 5, 2017, which are all hereby incorporated in their entirety by reference.

### TECHNICAL FIELD

The present disclosure relates to a method for computer-assisted determination of a cosmetic product and a data processing device and a device for carrying out the method.

### BACKGROUND

Nowadays, a user (also referred to as a consumer or customer) is confronted with a constantly growing number of products and product variations.

This also concerns the field of cosmetics, for example hair treatment products, skin treatment products, dental care products and decorative cosmetics. Some users feel overwhelmed when they stand in front of a shelf of products at a point of sale.

Therefore, there is a need for quick and objective orientation and guidance on the part of the user to find a suitable product.

### SUMMARY

A method for computer-assisted determination of a cosmetic product is disclosed. The method comprises the steps of: providing an activation signal to a portable data-processing device, the activation signal being configured to activate software in the portable data-processing device; providing product category information and user location information to the portable data-processing device; providing a plurality of possible target states in the portable data-processing device, taking into account the product category information; selecting a desired target state from the plurality of possible target states by a user; determining at least one cosmetic product which is suitable for bringing about the desired target state from a manufacturer-independent plurality of cosmetic product for which data on achievable states is stored in an external database; determining an availability of the at least one cosmetic product at a user location; and presenting the at least one cosmetic product, taking into account the availability of the user location.

The most important questions from the user's perspective are:

1.) What do I want to achieve (including starting point and desired end point)?
2.) Which products enable me to achieve this goal?
3.) Where do I find the products?

In various exemplary embodiments, a mobile consultant is provided at the point of sale (POS), which immediately provides advice and helps users to find the right product.

The consultant may include software that can run, for example, on portable data-processing devices (also referred to as devices such as smartphones, tablets, laptops or phablets/smartlets). The software may include a web page that opens in a web browser installed on the mobile device or an application (app) that is downloaded (once). Using a web page can be advantageous in that it is easy to use (it does not need to be downloaded), requires little additional storage space (a web browser such as Safari, Google Chrome, Opera, Mozilla . . . is available on virtually any smart device, so no additional storage space is needed for the mobile consultant), and is inexpensive to program and update (the presence of different operating system for mobile devices like iOS or Android requires programming and updating of different applications and application versions).

The smart device can be made to open the software (triggered) in several exemplary embodiments. In other words, the software can be activated, e.g. by an activation signal.

Examples of activation signals (triggers) include reading an NFC chip (NFC means a near field communication: a wireless data transmission, which is enabled over short distances by employing suitable components and protocols), which is mounted at the POS (for example the product shelf), by the smart device, reading a QR code, which is mounted at the POS (for example the product shelf), by the smart device on which a QR code reader is installed, reading a barcode, which is mounted at the POS (for example the product shelf), by the smart device, comprising a barcode reader, entering a URL (manually or by voice) attached to the POS (for example the product shelf), recognizing an acoustic command (noise, speech, music, jingle . . . ) by the smart device comprising a voice recognition module and/or manual activation by a touch-sensitive surface (for example opening an app by tapping).

The started software may be used in different exemplary embodiments to guide a user through different processes of a method for determining a cosmetic product. The method may include an analysis, an evaluation and a recommendation in different exemplary embodiments.

The analysis may include a desired target state in different exemplary embodiments (generally, a state expected after the application of the cosmetic product is called the final state). For example, the target condition may include a certain hair color, a certain hair style (strong stability, flexibility, long lasting stability . . . ), a normal skin moisture content, a sun protection factor of at least about 50, very shiny hair, smooth skin, more hair volume, less hair damage, cleaned skin using a certain ingredient, cleaned hair without using one or more ingredients, etc.

During the analysis, additional data may also be captured, such as an initial state (also known as off-state). The initial state may be, for example, an initial hair color, hair gloss, skin moisture, skin smoothness, etc.

The initial state may be determined in various exemplary embodiments using a questionnaire. In various exemplary embodiments, an analysis device may be used alternatively or additionally, for example an (e.g. optical) analysis device for determining the hair color (e.g. a camera) and/or the degree of hair damage (e.g. an NIR spectrometer, a microscope or similar), an analysis device for determining a skin moisture content (e.g. using electrodes), an (e.g. optical) analysis device for determining hair smoothness (e.g. a camera), etc.

The questionnaire may contain questions and predefined answer options in various exemplary embodiments. The questions and answers may include images, e.g. images with strands of hair of different colors, which make it possible or easier to select a hair color (e.g. the original hair color and/or the target hair color).

By employing the questionnaire, other or additional desired (or even to be avoided) properties of the cosmetic product may be captured alternatively or additionally, e.g. additional properties of hair colors (as a result of a dyeing process), such as a wash fastness, a light fastness, a gray covering ability, additional properties of skin and/or hair care products, such as a consistency (e.g. cream, gel, oil, etc.) a method of application (e.g. spray, cream), the need to use certain tools or to take precautions, the presence or absence of certain ingredients (e.g. allergens, parabens, preservatives, essential oils, etc.), particular characteristics of the ingredients or the manufacturing process (e.g. organic ingredients, without animal testing) or similar.

In various exemplary embodiments, the user may answer the questionnaire acoustically, for which purpose the portable electronic device may be equipped with voice recognition, or by touching a touch-sensitive screen of the portable data-processing device.

The extent of the analysis, i.e. what questions are asked of the user, may depend on the wishes/needs of the user. In a preferred embodiment the software may be started immediately with questions regarding the right product category. If, for example, the user's wish includes a certain hair color, the analysis or capture may start with a question regarding hair colors (e.g. the desired target hair color) with the help of the questionnaire. This may be achieved, for example, by ensuring that the start signal (the NFC chip, the URL, the voice command . . . ), which starts the software, also contains information about the product category. Alternatively, the product category may be requested after starting the software, e.g. hair coloring, hair care, skin care . . . for example as a selection menu (e.g. for tapping), as an acoustic request that requires a spoken response, or similar.

The analysis of the user's wishes/needs may include, in various exemplary embodiments, the determination of an initial state (e.g. current hair or skin condition, e.g. initial hair color, possible allergies or intolerances) and the desired target state (e.g. the hair color to be achieved or allergens to be avoided).

In various exemplary embodiments, the analysis of the user's wishes/needs may simply involve determining the desired final condition, for example, a paraben-free shampoo, a conditioner that creates more volume, a skin care cream for oily skin, skin care creams that have not been tested on animals, shampoos that mainly contain natural ingredients, a hair spray that creates a particularly strong stability, etc.

In various exemplary embodiments, the user's input may be evaluated in an evaluation and suitable products may be determined. A database and/or an algorithm may be used to do this. The database may include rules in several exemplary embodiments, which assign products to a given user input.

The database may be stored in various exemplary embodiments in an external computer, i.e. outside the portable data-processing device. Data may be exchanged by employing a wireless data connection in a known manner.

In various exemplary embodiments, the database may be stored alternatively or additionally in the portable data-processing device, for example as part of the app. The external storage may be advantageous in that, on the one hand, no storage space needs to be provided in the portable data-processing device for the entire database, because only information concerning the products of the portable data-processing device that are judged to be suitable is provided, and, on the other hand, updating/maintenance of the database is simplified. For example, in the case of a database stored externally, e.g. a centrally managed database, it is easy to add information at a later stage, such as new products, new test results on existing products, customer ratings, etc.

The database may also store the compositions and/or treatment purposes for one or more products from a product category in various exemplary embodiments. The product categories may include, for example, hair dyes, shampoos, hair sprays, skin creams, toothpastes, deodorants, etc. A search program may then search or filter the compositions in various exemplary embodiments depending on the user input. For example, the program may search for shampoo compositions that do not contain parabens or silicones or that achieve the desired effect (target state).

In the case of hair dye composition, in different exemplary embodiments, the coloring result of at least two, for example all, hair dye compositions applied to the chosen original hair color may be calculated using predictive analytics. Then those hair dye compositions may be calculated which produce hair color results that are closest to the desired target hair color. For example, the color difference ΔE may be used for this purpose.

The color difference ΔE may be used, for example, in such a way that all those products are considered suitable whose expected color difference between the calculated coloration result and the desired target hair color is smaller than a given threshold value, for example a threshold value for the color difference, at which the color difference between the desired target hair color and the hair coloration result would be perceived as small (ΔE<2.0), would be noticeable only to the trained eye (ΔE<1.0) or would be almost imperceptible (ΔE<0.5).

The database and/or the algorithm may have an artificial system that learns from examples and can generalize these after the learning phase is completed. This means that the examples are not simply remembered (for example, stored), but that patterns and irregularities in the learning data can be detected. Different approaches may be followed. For example, supervised learning, partially supervised learning, monitored learning, encouraging learning and/or active learning may be used.

In the recommendation phase, the software may recommend one or more products to the user, which are suitable for fulfilling the wishes or needs of the user.

For example, the user may be presented visually and/or acoustically with at least one, preferably at least two or more, suitable products. A range of recommended products may also include products from different companies/manufacturers.

In a case where more than one product is recommended, these products may be presented as a sorted or an unsorted list.

In the case of a sorted list, different sorting parameters may be used, for example, the list may be sorted by a degree of fit between the desired state and the state expected when the product is used, by a score reflecting customer satisfaction, taking into account a number of ratings given, by a ranking in a list of the most frequently sold products, by price (descending or ascending, depending on user preference), by the sustainability of the product according to a sustainability index, on the basis of whether the product is part of a current advertising campaign (with a discount, if applicable), etc. The data on the basis of which sorting of recommended products is performed, for example customer satisfaction or customer ratings, may come from different sources. These sources may include the websites of the product manufacturer, the websites of online sales platforms such as Amazon, the websites of rating portals and/or the websites of the online shop of the operator of the point of sale where the user is located.

According to an exemplary embodiment, the software can be set up to present to the user only those of the suitable products which are currently available in principle at the point of sale, e.g. those which are in stock. For this purpose, the software can use availability information (e.g. stock information) that refers to the point of sale (POS) at which the user is currently located. The point of sale information can be provided in various exemplary embodiments by the activation signal, for example by the NFC chip, the URL, spoken input or similar. The point of sale information may include, for example, a name of the store and/or an address of the store. The point of sale information may be used to draw conclusions about the products available at that point of sale. The availability information may be provided by the shop operator in various exemplary embodiments (e.g. daily or possibly with a longer time interval updated) and stored in the database.

According to an exemplary embodiment, the software may be set up to present the user only those suitable products that are actually available for sale at the point of sale, e.g. on the shelf. For this purpose, the software (or further software) may analyze those products that are currently on the shelf. A picture, for example, can serve as a basis for this analysis. The user may take, for example, one or more photos of the product shelf (for example, a product shelf on which hair dye products are placed) and the (further) software may associate the photographed objects with specific products and, for example, based on a design of the product and/or a barcode placed on the product or shelf. By restricting to actually available products, frustration for the user can be avoided.

As described above, in several exemplary embodiments, availability information may be used to limit the number of products recommended to the user based on their availability at a specific point of sale. In other words, availability information is used to filter a selection of processed and/or presented products in the process flow.

In several exemplary embodiments, filtering may result in the complete removal from the process flow of those products that are not available at the point of sale. In several other exemplary embodiments, filtering may be used to present those products that are currently not available to the user in a different way than the available products. For example, the list of recommended products may include a subset of available products and another subset of currently unavailable products. In the event that the user chooses one of the products which are currently unavailable, he/she may, for example, purchase this product via the online platform of the store.

Filtering may be carried out at different stages of the method in different exemplary embodiments. For example, filtering may be performed during the evaluation process, which can limit the number of products to be processed during an evaluation. Thus, a number of products that may be recommended to the user can be limited.

In various exemplary embodiments, the user may be shown a simulation of an expected result before or after the presentation of cosmetic products that enable or come close to achieving his desired result. For this purpose, a photo of the user can be used, which may have been taken, for example, by a camera of the portable data-processing device, or a photo provided to the portable data-processing device, for example, as a transmitted file.

The portable data-processing device may be set up, for example, by employing the software or by employing further software, to determine in the photo the area which would be affected by the application of the cosmetic product, e.g. the hair, and to display this area in a modified form so that a simulated representation of the user after application of the respective cosmetic product results. This process may be carried out in a manner that is in principle known. For example, such a method for simulating newly dyed hair in a digital photo of a user is known.

In various exemplary embodiments, the portable data-processing device may be set up to allow the user to select (further) from the presented plurality of possible products after displaying the expected result. In this case, the display of further information, e.g. on availability (including, if applicable, a location on the shelf where the product can be found), may be limited to those products that the user has selected. In other exemplary embodiments, further information may be displayed for all products of the plurality of possible products, whereby the scope of information may be the same for all possible products or may be different for the selected products and the non-selected products.

Various exemplary embodiments are described below.

Example 1 is a method for computer-assisted determination of a cosmetic product. The method may comprise providing an activation signal to a portable data-processing device, the activation signal being configured to activate software in the portable data-processing device, providing product category information and user location information to the portable data-processing device, providing a plurality of possible target states in the portable data-processing device taking into account the product category information, selecting a desired target state from the plurality of possible target states by the user, determining at least one cosmetic product which is suitable for bringing about the desired target state from a manufacturer-independent plurality of cosmetic products for which data on achievable states is stored in an external database, determining an availability of the at least one cosmetic product at the user location and presenting the at least one cosmetic product taking into account the availability at the user location.

In Example 2, the subject-matter of Example 1 may further optionally comprise providing a plurality of possible initial states in the portable data-processing device, taking into account the product category information and selecting an existing initial state from the plurality of possible initial states by the user, wherein, for the manufacturer-independent plurality of cosmetic products, associated initial states are also stored in the external database for the data on achievable states, and wherein, when determining the at least one cosmetic product, the initial state is taken into account in such a way that the suitable cosmetic product is suitable for bringing about the desired target state based on the initial state.

In Example 3, the subject-matter of Examples 1 or 2 may optionally include that the activation signal is provided by NFC, QR code scan, bar code scan, text input, audible input or keypad input.

In Example 4, the subject-matter of any of Examples 1 to 3 may optionally include that the activation signal and product category information is provided as a combined signal.

In Example 5, the subject-matter of any of Examples 1 to 3 may optionally include the activation signal and user location information as a combined signal.

In Example 6, the subject-matter of any of Examples 1 to 3 may optionally include that the activation signal, product category information and user location information are transmitted as a combined signal.

In Example 7, the subject-matter of Example 3 may optionally include that the acoustic input is a spoken input, wherein the portable data-processing device may be equipped with voice recognition software and may be configured to activate the software upon recognition of a predetermined voice command.

In Example 8, the subject-matter of Example 3 may optionally include that the acoustic input is a tone sequence, wherein the portable data processing apparatus may be equipped with a voice recognition software and may be set up to perform the activation of the software upon recognition of a predetermined tone sequence, for example a jingle.

In Example 9, the subject-matter of any one of Examples 1 to 8 may optionally show that the product category comprises a hair dye product, a hair care product, a hair styling product, a skin care product, a dental care product or a decorative cosmetic product.

In Example 10, the hair dye product of Example 9 may comprise a hair dye product for permanent or temporary coloring of hair.

In Example 11, the hair care product from Example 9 may include a hair shampoo, conditioner, hair conditioner, hair mask, hair oil or hair care fluid.

In Example 12, the hair styling product from Example 9 may include a hair spray, a hair gel, a hair wax or a hair reshaping agent, such as a perming agent or a straightener.

In Example 13, the skin care product from Example 9 may include a body cream, a body lotion, a face cream, a toner, a shower gel, a face cleanser, a lip care cream, a foot care cream, a hand cream, a sun cream or an after sun lotion.

In Example 14, the dental care product from Example 9 may include a toothpaste or mouthwash.

In Example 15, the decorative cosmetic product from Example 9 may include a lipstick, eye shadow, mascara, tinted cream, powder, kajal, undercoat or rouge.

In Example 16, the subject-matter of any of Examples 1 to 15 may optionally show that the user location is a cosmetic product sales facility.

In Example 17, the subject-matter of any of Examples 1 to 16 may optionally show that activating the software involves opening a browser or launching an app.

In Example 18, the subject-matter of any of Examples 1 to 17 may optionally show that the presentation of the at least one cosmetic product, taking into account the availability at the user's location, includes graying out of the unavailable suitable cosmetic products.

In Example 18, the subject-matter of any one of Examples 1 to 17 may optionally show that the presentation of the at least one cosmetic product, taking into account the availability at the user's location, includes a presentation of the appropriate cosmetic products as a first group of available products and a second group of unavailable products.

In Example 19, the subject-matter of Example 18 may also optionally show that when a product is selected from the second group of unavailable products, a link and/or an order form for an online order is provided.

In Example 20, the subject-matter of any of Examples 1 to 19 may also optionally include, prior to the presentation of the at least one cosmetic product, a filtering of the at least one cosmetic product, taking into account its availability at the user's location, taking into account at least one additional parameter.

In Example 21, the subject-matter of Example 20 may show that the at least one additional parameter concerns an ingredient, a pharmaceutical form, a method of application, a required application aid, a price and/or any other characteristic of the cosmetic product.

In Example 22, the at least one additional parameter of Examples 20 or 21 may be formulated as a positive property, i.e. availability of the ingredient, pharmaceutical form, method of application, required application aid, price and/or other property of the cosmetic product.

In Example 23, the at least one additional parameter of Examples 20 or 21 may be formulated as a negative property, i.e. absence of the ingredient, pharmaceutical form, method of administration, required application aid, price and/or other property.

In Example 24 at least one positive property from Example 22 may be combined with at least one negative property from Example 23.

In Example 25, the subject-matter of any of Examples 1 to 24 may also include a presentation of the expected result using a photograph of the user before the presentation of the at least one cosmetic product, taking into account the availability at the user's site.

In Example 26, the subject-matter of Example 25 may optionally exhibit that the expected result is an expected hair color, wherein the presentation of the expected result may include a presentation of the user's photograph in which a hair portion of the photograph in which the user's hair is depicted is re-colored using the expected hair color.

Example 27 is a portable data-processing device for carrying out a method for computer-assisted determination of a cosmetic product, the data processing device being configured to carry out the method according to any one of Examples 1 to 26.

In Example 28, the subject-matter of Example 27 may optionally include that the portable data-processing device is a smartphone, tablet, phablet, iPad or laptop.

In Example 29, the subject-matter of Examples 27 or 28 may optionally include that the portable data-processing device includes an NFC communication device.

In Example 30, the subject-matter of any of Examples 27 to 29 may optionally include that the portable data processing equipment includes a QR code scanner.

In Example 31, the subject-matter of any of Examples 27 to 30 may optionally include that the portable data-processing device includes a barcode scanner.

In Example 32, the subject-matter of any of Examples 27 to 31 may optionally include that the portable data-processing device includes a computer program for displaying web pages, documents and/or data on the World Wide Web (“browser”).

Example 33 is a device for computer-assisted identification of a cosmetic product. The device may be the portable data-processing device according to Example 32 and have an activation signal generator.

In Example 34, the subject-matter of Example 33 may show that the activation signal generator includes an NFC chip, a QR code or a barcode.

In Example 35, the subject-matter of Examples 33 or 34 may show that the activation signal device is mounted on or near a shelf on which cosmetic products are placed.

In Example 36, the subject-matter of any of Examples 33 to 35 may optionally show that the activation signal device is designed as a shelf wobbler, shelf stopper, shelf divider or scanner bar sign.

Examples of carrying out the present disclosure are shown in the figures and are explained in more detail below.

### BRIEF DESCRIPTION OF THE DRAWINGS

The present disclosure will hereinafter be described in conjunction with the following drawing figures, wherein like numerals denote like elements, and:

There it is shown that

FIG. 1 is a schematic diagram of a method for computer-assisted determination of a cosmetic product according to various exemplary embodiments;

FIG. 2 is a flow chart representing a method for computer-assisted determination of a cosmetic product according to various exemplary embodiments; and

FIG. 3 is a schematic diagram of a device for computer-assisted identification of a cosmetic product according to various exemplary embodiments.

### DETAILED DESCRIPTION

The following detailed description is merely exemplary in nature and is not intended to limit the disclosure or the application and uses of the subject matter as described herein. Furthermore, there is no intention to be bound by any theory presented in the preceding background or the following detailed description.

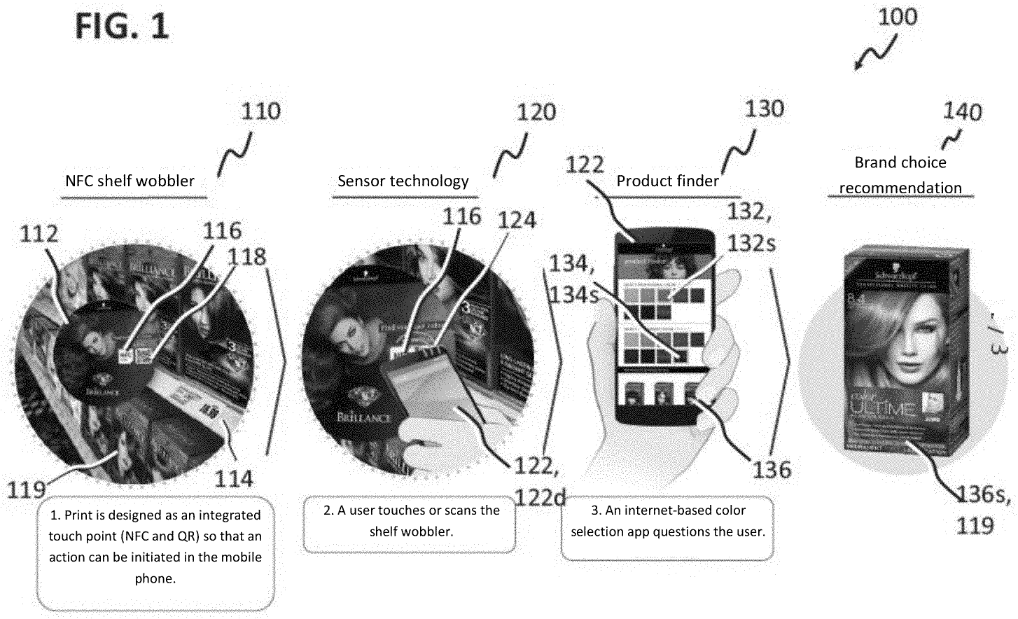

FIG. 1 shows a schematic representation of a method 100 for computer-assisted identification of a cosmetic product according to various exemplary embodiments.

For illustration purposes, FIG. 1 shows a determination of a hair dye. The method 100 may also be carried out mutatis mutandis to identify a product from another product category.

The user may stand in front of or next to a product shelf 114 at a point of sale (POS) shown in view 110, for example in a drugstore, perfumery, hairdressing salon or similar, on or in which products (here: hair dye products, also called hair coloration products) 119 are placed.

Hair dye products 119 may be suitable for producing different hair colors by employing different compositions, whereby the hair dye products may come from different manufacturers.

A so-called shelf wobbler 112 (or a marking of comparable functionality, e.g. a shelf stopper, shelf divider or scanner bar sign) may be placed on or near the shelf.

The shelf wobbler 112 may be configured to include an NFC chip 116 and/or a QR code 118, each of which may be capable of providing a signal 124 (see view 120). In other words, the shelf wobbler 112 may be configured as an integrated touch point that includes both the NFC chip 116 and the QR code 118. Alternatively, the shelf wobbler 112 could include only the NFC chip 116, only the QR code 118 and/or another form of signal provision, e.g. a barcode, a device that plays a characteristic sequence of tones when activated, or similar.

The signal 124 may be configured to initiate an action in a portable data-processing device 122, for example a smartphone 122.

In other words, receiving the signal 124 (e.g. as a scan of the QR code or as a transmission of data stored in the NFC chip 116 by employing NFC) may act as an activation signal. The activation signal may be set up to activate software in the portable data-processing device 122, for example to open a web page in a browser or to start an application (e.g. an app).

The signal may also include information about a product category of the products 119 located in the product shelf 114.

The product category information may be used in various exemplary embodiments to configure a basic setting during activation, for example, to open the web page that asks for the desired target state appropriate for the product category. In this example, as shown in view 130, a selection of target hair colors 134 may be provided, from which the user can select a target hair color (in view 130 this is color 134s). Alternatively, an app may be opened in such a way that the query matching the product category is presented to the user, and/or different apps may be provided for different product categories (e.g. different apps for hair dyes and hair care products).

In various exemplary embodiments, a general web page or app homepage may be presented after providing the activation signal. In this case, additional user input may be required to reach the homepage assigned to the product category.

Furthermore, in this example a color selection 132 for an initial hair color may be presented as an initial state, from which the user selects the hair color that comes closest to his current hair color. In this example the color 132s was selected.

In various exemplary embodiments, the portable data-processing device 122 may be set up to determine suitable hair colorants based on the initial hair color 132s and the desired target hair color 134s.

For hair dyes whose chemical composition is known, e.g. for all hair dye products of a certain manufacturer, the expected hair color after dyeing may be determined in a basically known manner.

For this purpose, methods from the field of predictive analytics may be used in various exemplary embodiments, for which the corresponding term “predictive analytics” is usually used (also known as “big data”, “data mining” or “machine learning”). This makes it possible to make precise calculations of the expected hair color (and possibly other properties, such as color fastness, light fastness, gray coverage, etc.) despite the fact that there may be many unknowns in a hair coloring process.

The hair color can be parameterized in a color space.

In this context, a “color” can be defined as a combination of a shade of color (i.e. a spectral color impression, also known as hue, which can be understood as what is known as the “actual color”), a color intensity (i.e. how intense the color appears, e.g. compared to a neutral gray, which is also called saturation, color saturation, chromaticity, chromacity or color depth) and a brightness (i.e. how light or dark the color appears).

In various exemplary embodiments, the color information may, for example, be parameterized in a known color space, such as an L*a*b* color space (where L* indicates the brightness of a color, a* the green and red components, and b* the blue and yellow components of the color; sometimes this is also referred to as Lab or individually L, a, and b, respectively) in an RGB color space by color components in red, green and blue, in a CMYK color space by color components in cyan, magenta, yellow and black, or in any other color space.

The term “hue” in this context, as described above, can be understood to mean the spectral color impression of a color, regardless of how it may be parameterized, for example as a point in a two-dimensional color space (e.g. a*b* of the L*a*b* system) or a ratio of color components (as in the case of the RGB color space or the CMYK color space).

In various exemplary embodiments, a color space from which the color information (e.g. the hair color information of the dyed hair or the original hair color) is derived, or in which the color information is represented (e.g. when a hair color is represented, see below), may be such that a determined or represented color is independent of a medium through which the color is determined or represented (e.g. colorimeter, monitor, printer, scanner, human eye, etc.). The color space can be, for example, an L*a*b* color space, the color information a shade of color parameterized by a* and b*, for example. The uniform representation in the medium-independent color space may, for example, allow the presentation of a realistic coloring result to be expected, e.g. a color obtained by dyeing leaves the same color impression on the observer of the dyed hair as in a representation of the result to be expected, e.g. on a display device 122d of the portable data-processing device 122.

Furthermore, for such a color space, e.g. the L*a*b* color space, the color difference ΔE may have the property that limits for a perceived color difference are independent of the color itself, i.e. that for both brown and blond hair, for example, color differences become perceptible to a trained eye from a color difference of approximately ΔE=1.0.

In various exemplary embodiments, predictive analytics can be used to create a model that predicts the hair color achieved (and possibly other hair color properties, see above) as accurately as possible for a given dye composition and initial hair color.

For the hair colors that can be achieved using hair dye 119 (all hair dyes or only the hair dyes available in principle or only the hair dyes actually present on product shelf 114) based on the initial hair color 132s, a color difference ΔE to the desired target hair color may be determined in various exemplary embodiments.

For hair dye products 119 whose chemical composition is not known, e.g. products of other manufacturers (therefore also referred to as competitors' hair dye products), it may be necessary to determine the expected hair color differently or to assign it to the product.

For this purpose, a limited number of (test) initial hair dyes may be provided in various exemplary embodiments, of which one is assigned to each competitor's hair dye product. A so-called “mean application range”, which is usually indicated on the packaging of a hair dye product, may be used for the allocation.

After coloring all competitors' hair dye products on their respective (test) initial hair color, the achieved (competitor's) hair color may be specified as a color parameterized in a color space (e.g. the L*a*b* color space) by a colorimetric measurement.

For each coloring by the hair dye products with the known compositions on each of the (test) initial hair colors, that competitor's product is determined which was dyed on the same initial hair color and has the narrowest color difference ΔE.

Accordingly, for hair dye 119, which has the narrowest color difference ΔE to the desired hair color, the competitors' hair dye may be determined which has the narrowest color difference ΔE to the desired hair color.

Hair dye 119 and the competitor's hair dye can then be jointly provided to the user as suitable products 136, for example as shown in view 130.

In various exemplary embodiments, the point of sale information can be used, as described above, to adapt the presentation of the suitable hair dyes 136 to their availability at the POS, e.g. as a grayed-out display of the unavailable agents 136, as a division into available and unavailable groups/lists, possibly with an option to order the unavailable products 136.

The user can choose his preferred product 136s, 119 in various exemplary embodiments, for example by touching the screen (see view 140). A detailed presentation of the packaging may help the user to find the product 136s, 119 in product shelf 114 and/or a redirection to a web page of the selected product may provide additional information about the product 136s, 119, such as customer comments, product ratings, ingredients, usage, etc. Alternatively or additionally, a location of the product on product shelf 114 may be displayed or otherwise provided to the user.

In various exemplary embodiments, as described above, the software may also be set up to provide the user with a representation of himself with the selected product 136s or any of the appropriate products 136 (not illustrated).

In various exemplary embodiments, as described above, the software may also be set up to restrict the product selection by employing filtering with regard to further properties (e.g. composition, application, etc., as also explained above using examples). In various exemplary embodiments, this may be done before determining the products suitable for achieving the desired target hair color, which may possibly reduce the calculation effort and data volume to be transferred. In several exemplary embodiments, filtering may be done after the appropriate hair dyes have been provided.

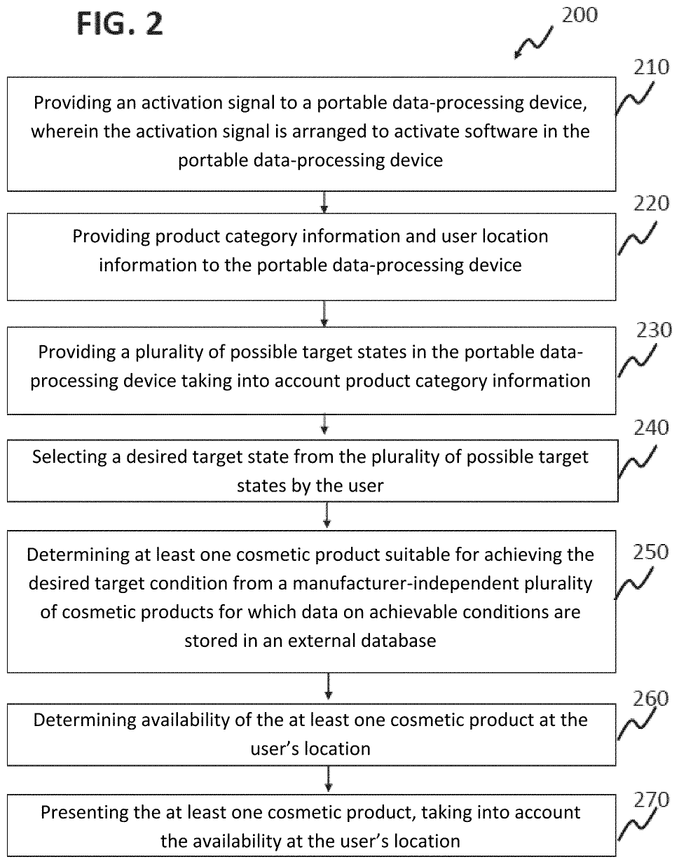

FIG. 2 is a flowchart 200, which represents a method for computer-assisted determination of a cosmetic product according to various exemplary embodiments.

The method may include providing an activation signal to a portable data-processing device, the activation signal being configured to activate software in the portable data-processing device (at 210), providing product category information and user location information to the portable data-processing device (at 220), providing a plurality of possible target states in the portable data-processing device, taking into account the product category information (at 230), selecting a desired target state from the plurality of possible target states by employing the user (at 240), determining at least one cosmetic product which is suitable for bringing about the desired target state from a manufacturer-independent plurality of cosmetic products for which data on achievable states is stored in an external database (at 250), determining an availability of the at least one cosmetic product at the user location (at 260) and presenting the at least one cosmetic product, taking into account the availability at the user location (at 270).

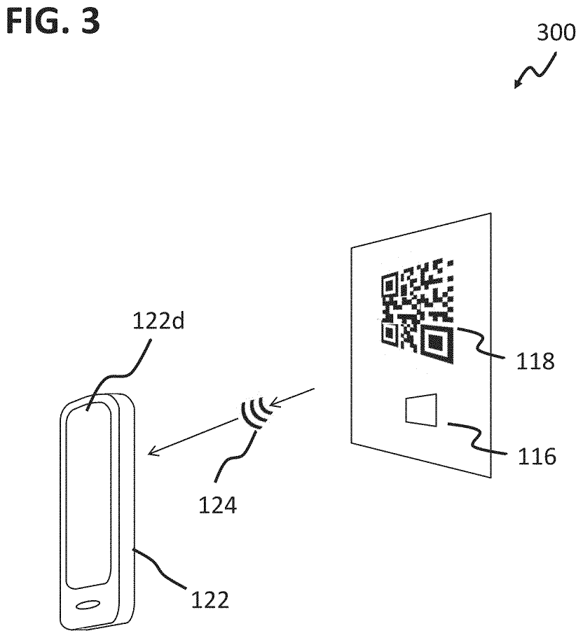

FIG. 3 is a schematic diagram of a device 300 for computer-assisted identification of a cosmetic product according to various exemplary embodiments.

The device 300 may comprise a portable data-processing device 122 which is suitable for carrying out the method for computer-assisted determination of a cosmetic product, for example comprising a sufficiently large memory and a sufficiently powerful processor, for example a microprocessor. The portable data-processing device 122 may for example be a smartphone, a tablet, an iPad, a laptop or a phablet/smartlet.

In various exemplary embodiments, the portable data-processing device 122 may include a display device 122d. For example, display device 122d may have a screen of the portable data-processing device 122. The display device 122d may be used, for example, to display the results of a method for computer-assisted determination of a cosmetic product, to request input parameters for carrying out the method, or the like.

In various exemplary embodiments, the portable data-processing device 122 may include an input device for providing information to the portable data-processing device 122, for example a touch-sensitive surface of the display device 122d, a microphone for inputting acoustic signals, a camera for detecting optical signals (as an example optical signal a QR code 118 is shown for providing a signal 124; alternatively, a barcode could be used), a device for data exchange by employing NFC (for example, the NFC chip 116 is shown as a signal generator, the signal receiver for the signal 124 in the portable data-processing device 122 is not shown) or similar.

Signal 124, which may be provided to the portable data-processing device 122 by one of the means described or by any other appropriate means, may include the activation signal described above. In addition, signal 124 may include product category information and/or point of sale information in various exemplary embodiments.

Other advantageous configurations of the method result from the description of the device and vice versa.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

1. A method for computer-assisted determination of a cosmetic product, the method comprising the steps of:
providing an activation signal to a portable data-processing device, the activation signal being configured to activate software in the portable data-processing device;
providing product category information and user location information to the portable data-processing device;
providing a plurality of possible target states in the portable data-processing device, taking into account the product category information;
selecting a desired target state from the plurality of possible target states by a user;
determining at least one cosmetic product which is suitable for bringing about the desired target state from a manufacturer-independent plurality of cosmetic products for which data on achievable states is stored in an external database;
determining an availability of the at least one cosmetic product at a user location; and
presenting the at least one cosmetic product, taking into account the availability at the user location.

2. The method according to claim 1, further comprising the steps of:
providing a plurality of possible initial states in the portable data-processing device, taking into account the product category information; and
selecting a present initial state from the plurality of possible initial states by the user,
wherein, for the manufacturer-independent plurality of cosmetic products, for the data on achievable states in the external database, associated initial states are further stored; and
wherein, in determining the at least one cosmetic product, the initial state is taken into account such that the appropriate cosmetic product achieves the desired target state from the initial state.

3. The method according to claim 1,
wherein the activation signal is provided by NFC, QR code scan, barcode scan, text input, acoustic input, or key input.

4. The method according to claim 1,
wherein the activation signal, the product category information, and the user location information are transmitted as a combined signal.

5. The method according to claim 1,
wherein the product category comprises a hair dyeing product, a hair care product, a hair styling product, a skin care product, or a decorative cosmetic product.

6. The method according to claim 1,
wherein the user location is a cosmetic product sales facility.

7. The method according to claim 1,
wherein activation of the software involves opening a browser or starting an app.

8. The method according to claim 1,
wherein the presentation of the at least one cosmetic product, taking into account the availability at the user location, shows a graying out of unavailable cosmetic products.

9. The method according to claim 1, further comprising the step of:
prior to the presentation of said at least one cosmetic product, taking into account the availability at the user location, filtering the at least one cosmetic product, taking into account at least one additional parameter.

10. The method according to claim 9,
wherein the at least one additional parameter includes an ingredient, a pharmaceutical form, a method of application, a required application aid, and/or a price of the cosmetic product.

11. The method according to claim 1, further comprising the step of:
prior to the presentation of the at least one cosmetic product, taking into account the availability at the user location, presenting an expected result using a photograph of the user.

12. A portable data-processing device for carrying out a computer-assisted determination of a cosmetic product, the data processing device being configured to carry out the method according to claim 1.

13. A device for computer-assisted determination of a cosmetic product, comprising:
the portable data-processing device according to claim 12 and an activation signal generator.

14. The device according to claim 13,
wherein the activation signal transmitter comprises an NFC chip, a QR code and/or a barcode.

15. The device according to claim 13,
wherein the activation signal transmitter is mounted on or near a shelf on which cosmetic products are placed.
